(19) United States
(12) Patent Application Publication
(10) Pub. No.: US 2019/0393626 A1
(43) Pub. Date: Dec. 26, 2019

(54) COVER DEVICE FOR A SHEATH CLAMP

(71) Applicant: Phoenix Contact GmbH & Co. KG, Blomberg (DE)

(72) Inventors: Joachim Bury, Herford (DE); Thomas Salomon, Verl (DE)

(21) Appl. No.: 16/465,776

(22) PCT Filed: Nov. 7, 2017
(86) PCT No.: PCT/EP2017/078399

§ 371 Date: May 31, 2019

(30) Foreign Application Priority Data
Dec. 2, 2016 (DE) 10 2016 123 322.6

(51) Int. Cl. H01R 9/24; H01R 4/30

(52) U.S. Cl. CPC H01R 9/24; H01R 9/2475; H01R 4/30

(57) ABSTRACT

The disclosure relates to a cover device for covering a sheath clamp on a terminal block that may be used in a mounting system. The cover device may include an insulating body configured to rotatably support a nut, and a protection component that fastens the insulating body on the terminal block to prevent loss of the insulating body, where the protection component includes an elastic tab. The mounting system may include a cover device that includes an insulating body configured to rotatably support a nut, and a protection component including an elastic tab; and a terminal block, where the terminal block includes a fixing opening to insert the protection component together with a latch, and where the protection component fastens the insulating body on the terminal block to prevent loss of the insulating body.

### CROSS-REFERENCE TO RELATED APPLICATIONS

This application is a 371 national phase filing of International Application No. PCT/EP2017/078399, entitled “COVER DEVICE FOR A SHEATH CLAMP”, filed 7 Nov. 2017, which claims priority to German Patent Application No. 10 2016 123 322.6, entitled “ABDECKVORRICHTUNG FÜR EINE MANTELKLEMME”, filed 2 Dec. 2016.

### BACKGROUND

### Technical Field of the Invention

The disclosure relates to a cover device for covering a sheath clamp on a terminal block having an insulating body, which is configured to rotatably support a nut, and a protection against loss in order to fasten the insulating body to a terminal block. A conventional example of a connector block as known in installation technology is a terminal block. Sheath clamps are arranged in a row in such terminal blocks in order to contact and fix wires or cable ends.

### Technical Background of the Invention

Sheath clamps have already been known in electrical installation technology in different variants for a long time. In sheath clamps, the threaded bolt is slotted axially so that an upwardly opened U-shaped fork is formed from the two lateral threaded domes. Wires and cable ends can be inserted here and be clamped by a nut. The nut can be lost. This can result in the loss of the nut in terminal compartments that are cramped or difficult to access. Due to the required accessibility, the metal nuts are moreover not protected against accidental contact. For this purpose, cover devices that are easily attached to the nut are known in the prior art. These cover devices are however disadvantageous in that they can be easily lost.

Document DE 10 2014 102 659 A1 describes a sheath clamp for producing a conductive contact, which sheath clamp comprises a threaded bolt for inserting a cable and a cap nut for screwing onto the threaded bolt, with an insulating body in which the cap nut is rotatably supported, with a lateral plug section, and a base plate on which the threaded bolt is fastened.

### SUMMARY

The object of the present disclosure is to provide an improved, loss-proof cover device for covering a sheath clamp on a terminal block and an improved mounting system for a terminal block that simplifies the mounting process and the handling of a terminal block.

This object is achieved by the subject matter with the features according to the independent claims. Advantageous examples of the disclosure are the subject matter of the figures, the description and the dependent claims.

According to one aspect of the disclosure, the object is achieved by a cover device for covering a sheath clamp on a terminal block, comprising an insulating body, which is configured to support a nut rotatably, and a protection against loss in order to fasten the insulating body to a terminal block, wherein the protection against loss is configured as an elastic tab. For example, this achieves the technical advantage of being able to arrange the cover device easily and efficiently on a terminal block. In this case, the protection against loss ensures that the cover device can be removed with the nut from the sheath clamp and deposited next to the clamping space as needed, without risking the loss of the cover device. Optimal elasticity and rigidity with simultaneous flame protection is given by means of a particularly suitable material selection, such as polyamide.

According to a preferred example, the nut is configured as a union nut or as a cap nut. This corresponds to customary and proven nut types, whereby the most versatile possible applicability is given.

In order to realize a regulated and controlled removal of the cover device and to design the clamping space to be freely accessible, the protection against loss is configured to be arc-shaped.

According to a preferred example, the protection against loss has a latching means. For example, this achieves the technical advantage of the protection against loss being able to be secured on the terminal block by easily arranging by means of the latching means.

In order to ensure free accessibility of the clamping space, the latching means is arranged on an end of the protection against loss facing away from the insulating body. This is in particular advantageous in connection with the arc-shaped design of the protection against loss.

According to a particularly preferred example, the latching means is configured as a barb. For example, this achieves the technical advantage that the latching means can be produced particularly easily and cost-effectively. A simple barb moreover has the advantage that it can on the one hand be inserted into an opening easily but, as a result of the barb, can only be removed therefrom with much more difficulty.

In order to fix the cover device in its end position on the terminal block, the cover device has a detent for latching in an end position of the insulating body on a terminal block. A particularly easy and favorable production can be realized when the detent is arranged on an end of the protection against loss facing the insulating body.

According to another preferred example, the insulating body is configured to be cylindrical. For example, this achieves the technical advantage of the cover device being particularly easy to produce and being able to be attached to the round nut very easily.

In order to facilitate the attachment of the insulating body to a nut, the cover device comprises a plug section in order to arrange the insulating body on a nut. The plug section can in this case be configured with simple longitudinal slots in the insulating body, for example. Alternatively or additionally, snap-in means can be arranged on the open end of the insulating body.

According to a preferred example, the threaded nut is configured as a cap nut with an internally arranged, coaxially rotatably supported pressure piece. The flanks of the pressure piece, which radially project beyond the cap nut, enter through the longitudinal slots in the insulating body and thereby produce a fixing of the position of the pressure piece in relation to the slot of the sheath clamp, which significantly facilitates the handling during attachment of the insulating body to the terminal block.

According to yet another preferred example, the cover device has a supporting device for receiving a marking element. As a result, each individual cover device can, for example, be marked or labeled easily.

In order to remove the insulating body particularly easily from the terminal block or in order to clear at least the clamping region, the cover device has a grip element for raising the cover device.

According to another preferred example, the insulating body comprises an opening with a circumferential collar for turning a nut by means of a tool. This can achieve the technical advantage of ensuring the accessibility of the nut, wherein the contact safety of the sheath clamp is improved at the same time.

According to a further aspect of the disclosure, the object is achieved by a mounting system with a cover device for covering a sheath clamp on a terminal block and with a terminal block, wherein the terminal block has a fixing opening in order to insert the protection against loss together with the latching means. This realizes the advantage of being able to arrange the cover device easily and efficiently on a terminal block. In this case, the protection against loss ensures that the cover device can be removed from the sheath clamp and deposited next to the clamping space as needed, without risking the loss of the cover device.

According to a preferred example, the terminal block has guiding means in order to arrange the cover device at the correct position on the terminal block. This facilitates the mounting of the entire terminal block and in particular the arranging of the cover device at the correct position.

In order to fix the cover device on the terminal block in the end position and in order to prevent any slipping, the terminal block has an engaging means, which corresponds to the detent of the cover device, in order to fix the insulating body in an end position.

### BRIEF DESCRIPTION OF THE DRAWINGS

Further design examples of the disclosure are illustrated in the drawings and are described in more detail in the following.

FIG. 1 shows a schematic illustration of a cover device,

FIG. 2 shows a further schematic illustration of a cover device in various views,

FIG. 3 shows a schematic sectional view of a cover device,

FIG. 4 shows a schematic sectional view of a mounting system,

FIG. 5 shows a schematic lateral view of a mounting system, and

FIG. 6 shows a perspective illustration of a mounting system.

### DETAILED DESCRIPTION

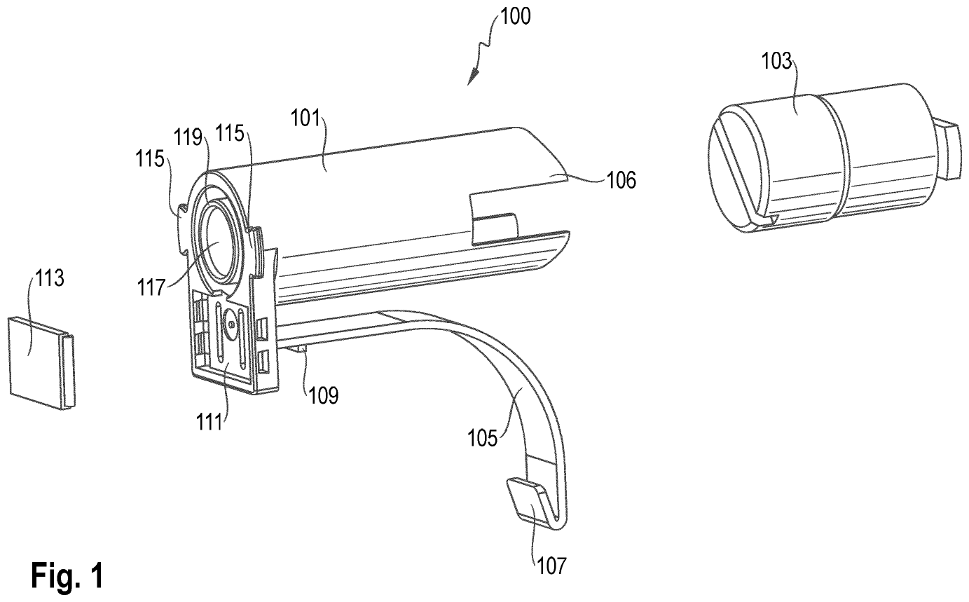

FIG. 1 shows a schematic illustration of a cover device 100. The cover device 100 comprises an insulating body 101, which is configured to support and hold a nut 103 latched, in that this insulating body can easily be attached to the nut 103 and holds the nut latched by means of snap-in means. To this end, the insulating body 101 is configured to be cylindrical and comprises a plug section 106. The latter facilitates attaching to the nut 103.

A supporting device 111 for receiving a marking element 113 is located on an end of the insulating body 101 opposite the plug section 106. The marking element 113 can in this case be removed and replaced by another marking element 113. Directly adjacent to the supporting device 111 are grip elements 115 arranged laterally on the insulating body 101 in order to raise the cover device 100. This significantly facilitates removal of the cover device 100.

An opening 117 with a circumferential collar 119 is arranged between the grip elements 115 arranged laterally on the insulating body 101. For example, this makes it possible to turn a nut 103 by means of a tool.

The cover device 100 additionally comprises an elastic protection against loss 105 configured to be arc-shaped. A barb-shaped latching means 107 is located on an end of the protection against loss 105 facing away from the insulating body 101 in order to attach the cover device 100 to a terminal block 102. The latching means 107 thus offers protection against pulling out of a receiving space 207 (see FIG. 4), which is arranged in the terminal block 102.

A detent 109 is additionally arranged on the protection against loss 105 in order to latch the insulating body 101 in an end position on a terminal block 102. To this end, the terminal block 102 comprises an engaging means 205 (see FIG. 4), which corresponds to the detent 109, in order to fix the insulating body 101 in the end position.

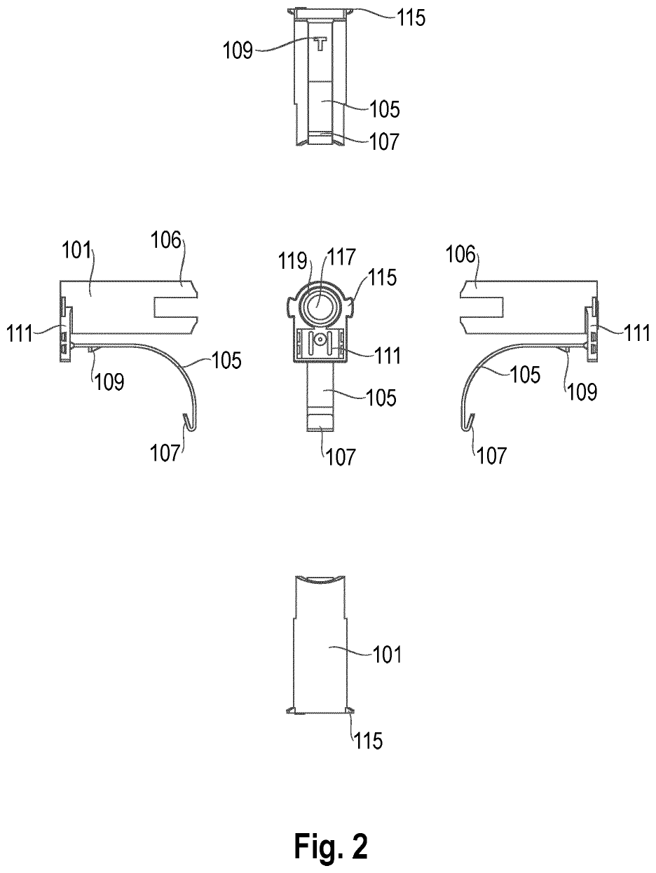

FIG. 2 shows another schematic illustration of a cover device 100 in various views. The various views illustrate the individual features of the cover device 100.

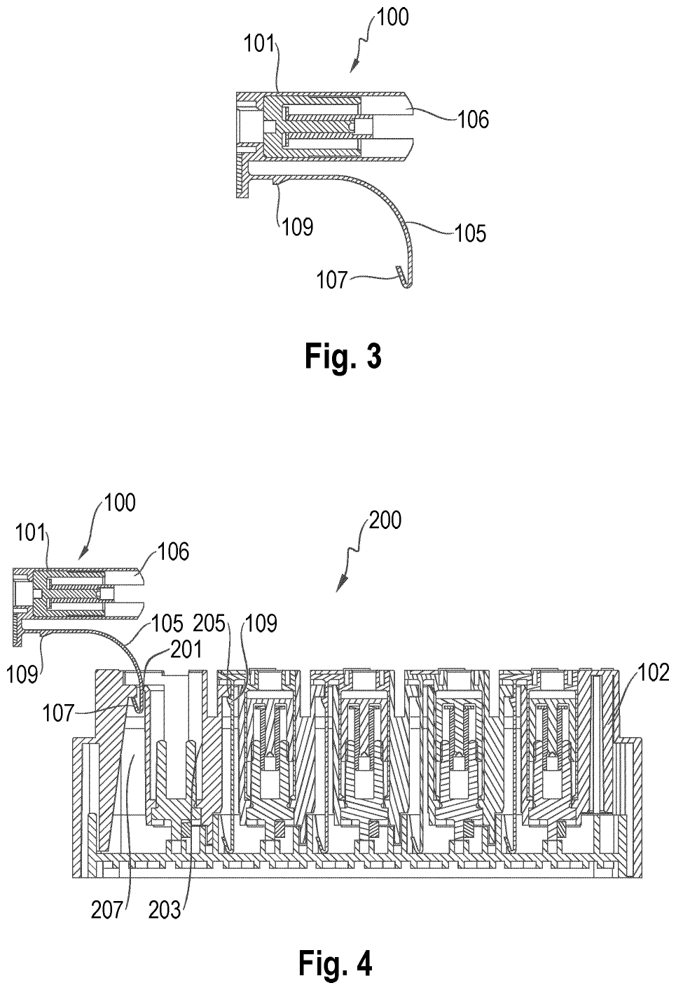

FIG. 3 shows a schematic sectional view of a cover device 100 with the insulating body 101, which is configured to receive a nut 103. The cylindrical insulating body 101has the plug section 106 for attaching to the nut 103. The cover device 100 moreover comprises the elastic and arc-shaped protection against loss 105 with the barb-shaped latching means 107 and the detent 109 for fixing the insulating body 101 in the end position on the terminal block 102.

FIG. 4 shows a schematic sectional view of a mounting system 200 with the terminal block 102 and the cover device 100. The protection against loss 105 of the cover device 100 is connected to the terminal block 102 via the barb-shaped latching means 107. To this end, the latching means 107 is inserted into the fixing opening 201 and extends into the receiving space 207.

The terminal block 102 has a guiding means 203 For a simplified and precise arrangement of the cover device 100 on the terminal block 102. The latter allows for arranging the cover device 100 at the correct position.

The terminal block 102 additionally has engaging means 205, which correspond to the detent 109 of the cover device 100. Thus, easy latching of the cover device 100 can be realized.

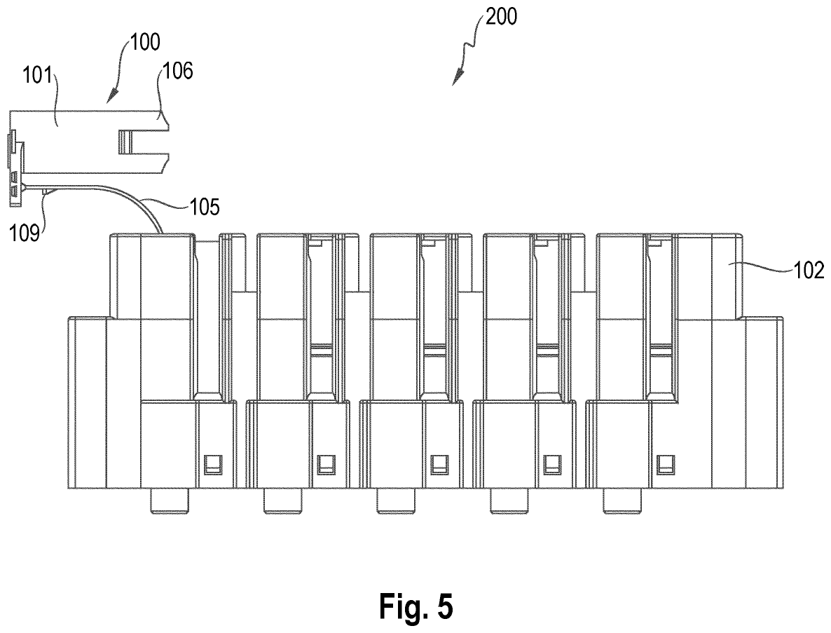

FIG. 5 shows a schematic lateral illustration of a mounting system 200. The protection against loss 105 of the cover device 100 is connected to the terminal block 102 via the barb-shaped latching means 107. A repeated description of identical features of the preceding figures is dispensed with.

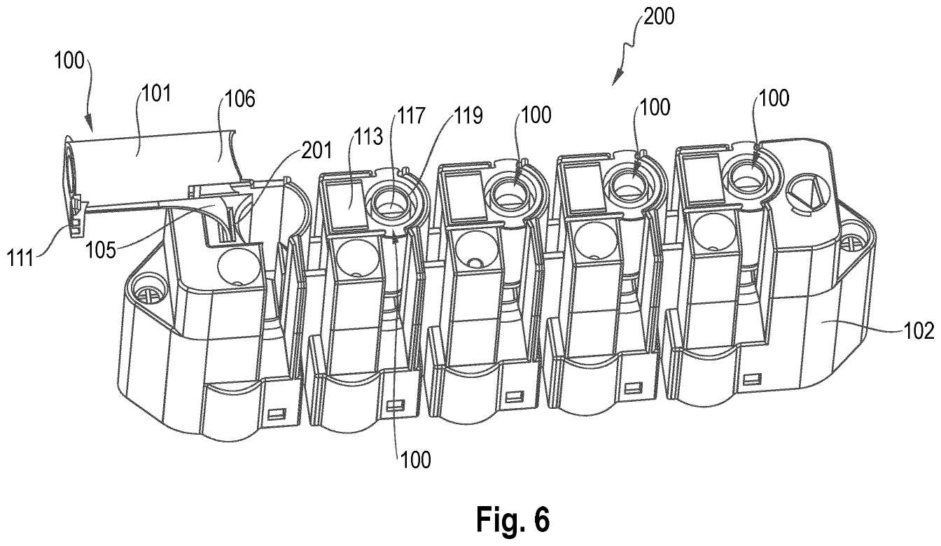

FIG. 6 shows a perspective illustration of a mounting system 200. Four cover devices 100 are already fixed in the end position on the terminal block 102. A fifth cover device 100 is connected to the terminal block 102 only via the barb-shaped latching means 107, which is inserted into the fixing opening 201 of the terminal block 102. The protection against loss 105 ensures that the cover device 100 can be deposited next to the clamping space, so that there is no risk of loss of the cover device 100.

All the features explained and shown in connection with individual examples of the disclosure can be provided in different combinations in the subject matter according to the disclosure in order to implement the advantageous effects thereof simultaneously.

### LIST OF REFERENCE NUMBERS

100 Cover device
101 Insulating body
102 Terminal block
103 Nut
105 Protection against loss
106 Plug section
107 Latching means
109 Detent
111 Supporting device
113 Marking element
115 Grip element
117 Opening
119 Collar
200 Mounting system
201 Fixing opening
203 Guiding means
205 Engaging means
207 Receiving space

What is claimed is:

1-16. (canceled)

17. A cover device for covering a sheath clamp on a terminal block, comprising:
an insulating body configured to rotatably support a nut, and
a protection component that fastens the insulating body on the terminal block to prevent loss of the insulating body, wherein the protection component comprises an elastic tab.

18. The cover device according to claim 17, wherein the nut is a union nut or a cap nut.

19. The cover device according to claim 17, wherein the protection component is arc-shaped.

20. The cover device according to claim 19, wherein the protection component comprises a latch.

21. The cover device according to claim 20, wherein the latch is on an end of the protection component facing away from the insulating body.

22. The cover device according to claim 20, wherein the latch is a barb.

23. The cover device according to claim 17, wherein the cover device comprises a detent configured to latch in an end position of the insulating body on the terminal block.

24. The cover device according to claim 23, wherein the detent is on an end of the protection component facing the insulating body.

25. The cover device according to claim 17, wherein the insulating body is cylindrical.

26. The cover device according to claim 17, wherein the cover device comprises a plug section configured to arrange the insulating body on the nut.

27. The cover device according to claim 17, wherein the cover device comprises a supporting device configured to receive a marking element.

28. The cover device according to claim 17, wherein the cover device comprises a grip element configured to raise the cover device.

29. The cover device according to claim 17, wherein the insulating body comprises an opening with a circumferential collar configured to turn the nut using a tool.

30. A mounting system comprising:
a cover device comprising:
an insulating body configured to rotatably support a nut, and
a protection component comprising an elastic tab; and
a terminal block, wherein the terminal block comprises a fixing opening to insert the protection component together with a latch, and wherein the protection component fastens the insulating body on the terminal block to prevent loss of the insulating body.

31. The mounting system according to claim 30, wherein the terminal block comprises a guide configured to arrange the cover device at a correct position on the terminal block, and the cover device comprises a detent.

32. The mounting system according to claim 31, wherein the terminal block comprises an engaging portion that corresponds to the detent of the cover device and is configured to fix the insulating body in an end position.

33. The mounting system according to claim 32, wherein the detent of the cover device is configured to latch in the end position of the insulating body on the terminal block.

34. The mounting system according to claim 32, wherein the engaging portion is positioned on an edge of the mounting system opposite the nut.

35. The mounting system according to claim 30, wherein the nut is a union nut or a cap nut.

36. The mounting system according to claim 30, wherein the protection component is arc-shaped.
